(19) United States
(12) Patent Application Publication
(10) Pub. No.: US 2026/0219219 A1
(43) Pub. Date: Jul. 30, 2026

(54) CLOUD POINT MEASURING APPARATUS FOR SILICONE SURFACTANT

(71) Applicant: JIANGSU HENGGUANG NEW MATERIAL CO., LTD., NANTONG (CN)

(72) Inventors: ZHONGJUN LI, BOZHOU (CN); ZHEN LI, BOZHOU (CN); GUANG LI, SUZHOU (CN)

(21) Appl. No.: 19/073,544

(22) Filed: Mar. 7, 2025

(30) Foreign Application Priority Data
Jan. 24, 2025 (CN) 202510114217.3

(51) Int. Cl. G01N 25/12

(52) U.S. Cl. CPC G01N 25/12

(57) ABSTRACT

Disclosed is a cloud point measuring apparatus for a silicone surfactant, including a sewage discharge assembly, a heating and stirring assembly, and a detection assembly. Clear water in a transparent test tube is not contact with a solution in a detection bottle, so that the clear water always remains clear. Inner and outer contours of a piston block are tightly fitted against the transparent test tube and the detection bottle respectively, and a light-guiding layer is disposed in the interior of the piston block, so that the light-guiding layer can guide the color of the clear water to a surface of the detection bottle. When the color of the solution changes at a cloud point, test personnel or a visual detection device can determine that the cloud point of the silicone surfactant is reached based on the light-guiding layer and an obvious change in the color of the solution.

### CROSS REFERENCE TO RELATED APPLICATIONS

The present disclosure claims the priority to the Chinese patent application with the filing NO. 202510114217.3, entitled “CLOUD POINT MEASURING APPARATUS FOR SILICONE SURFACTANT” and filed on Jan. 24, 2025 with the Chinese Patent Office, the contents of which are incorporated in the present disclosure by reference in their entirety.

### TECHNICAL FIELD

The present application relates to the technical field of chemical sample analysis, and specifically, to a cloud point measuring apparatus for a silicone surfactant.

### BACKGROUND

Silicone surfactants have become a research hotspot in recent years. Their molecular structures are different from those of ordinary hydrocarbon surfactants. A hydrophobic main chain of a silicone surface active material is composed of alkyl siloxanes, giving them stronger hydrophobic properties compared with conventional carbon chain hydrocarbon surfactants. In a solution at an equal concentration, the silicone surfactant exhibits lower surface activity. Additionally, the high bond energy (105 kcal/mol) of a hydrophobic group Si—O enhances the stability of the silicone surfactants. Due to unique advantages of silicone surfactants, such as low surface tension, high emulsification effect, high compatibility, foaming, foam-stabilizing, and anti-foaming properties, as well as non-toxicity, they have been widely applied to the fields of textiles, cosmetics, plastics, mechanical processing, coatings, medicine, and the like. A cloud point is an important quality control indicator for surfactants and is affected by a molecular structure of the surfactant and coexisting substances. An aqueous solution of the silicone surfactant is initially clear. As the temperature rises, a hydrogen bond between a hydrophilic group in a sample and hydrogen bonds of water break, causing immiscibility of the two phases, turbidity of the solution, and appearance of distinct phases. As the temperature further rises, the surfactant changes from a completely dissolved state to a partially dissolved state, and the solution changes from clear to turbid. The temperature at which the solution changes is the cloud point. Measurement of the cloud point is crucial to determination of the optimal operating temperature of the to-be-tested sample.

Designs of the cloud point measuring apparatuses disclosed in the prior art are relatively complicated. Most of them require separate preparation of various cloud point test solutions, and then samples are weighed in proportion for heating. Different cloud point test solutions have different mass ratios, and the designs are relatively complicated, which is inconvenient in process production research.

Therefore, in view of this, the existing structure and defects are studied and improved, and a cloud point measuring apparatus for a silicone surfactant is proposed.

### SUMMARY

An objective of the present application is to provide a cloud point measuring apparatus for a silicone surfactant, to solve the problem raised in the background art.

To achieve the foregoing objective, the present application provides the following technical solutions. A cloud point measuring apparatus for a silicone surfactant is provided, which includes a sewage discharge assembly, a heating and stirring assembly, and a detection assembly. The heating and stirring assembly is disposed outside the top of the sewage discharge assembly, and the detection assembly is disposed outside the top of the heating and stirring assembly. The detection assembly includes a detection bottle, an air inlet pipe, an air outlet pipe, a drainage groove, a water-isolating valve layer, a water inlet pipe, and a butt joint. The air inlet pipe is connected to a left end of the top of the detection bottle, the air outlet pipe is arranged at a right end of the top of the detection bottle, the drainage groove is formed at the bottom of the detection bottle, the water-isolating valve layer is disposed inside the drainage groove, the water inlet pipe is connected to the exterior of the detection bottle, the butt joint is arranged on the top of the detection bottle, and a magnetic rotor is disposed at the inner bottom of the detection bottle.

Further, the sewage discharge assembly includes a fixed seat, an electric control push rod, a sewage discharge seat, a butt pipe, a sewage discharge hose, and a sewage port. The electric control push rod is arranged in the middle of the interior of the fixed seat, the sewage discharge seat is arranged at an output end of the electric control push rod, the butt pipe is connected to the exterior of the top of sewage discharge seat, the sewage discharge hose is connected to the exterior of the sewage discharge seat, and the sewage discharge port is arranged at the exterior of the fixed seat.

Further, the butt pipe is communicated with the sewage discharge pipe through the sewage discharge seat, and the sewage discharge hose is communicated with the sewage discharge port.

Further, the heating and stirring assembly includes a butt base, a heating layer, a magnetic stirrer, and a through groove. The heating layer is arranged inside the butt base, the magnetic stirrer is arranged in the middle of the interior of the butt base, and the through groove is formed inside the butt base.

Further, an outer contour of the detection bottle is matched with an inner contour of the butt base, and a bottom surface of the detection bottle is tightly fitted against a top surface of the magnetic stirrer.

Further, the magnetic stirrer drives the magnetic rotor to rotate, and the position and dimension of the through groove are in one-to-one correspondence with the position and dimension of the butt pipe.

Further, the air inlet pipe, the air outlet pipe, and the water inlet pipe are communicated with the interior of the detection bottle, and the detection bottle and the butt joint are integrated.

Further, a first fixed plug is disposed inside the butt joint, a transparent test tube is disposed inside the first fixed plug, a second fixed plug is disposed on an inner side of the top of the transparent test tube, a thermometer is disposed inside the second fixed plug, a piston block is arranged inside the detection bottle, and a light-guiding layer is arranged in the middle of the interior of the piston block.

Further, the electric control push rod drives the butt pipe to move upward to push open the water-isolating valve layer and pass through the drainage groove, and the butt pipe is communicated with the interior of the detection bottle after passing through the drainage groove.

Further, an outer contour of the piston block is tightly fitted against an inner wall of the detection bottle, and an inner contour of the piston block is tightly fitted against an outer wall of the transparent test tube.

The present application provides the cloud point measuring apparatus for a silicone surfactant, which has the following beneficial effects.

1. In the present application, a solution in the detection bottle is heated by using the heating layer. The magnetic stirrer drives the magnetic rotor to rotate, and the magnetic rotor mixes the solution during rotation to ensure that a silicone surfactant is uniformly mixed with deionized water. When the temperature rises to a cloud point of the silicone surfactant, the solution becomes turbid and the color changes. Because clear water in the transparent test tube is not contact with the solution in the detection bottle, the clear water can always remain clear. The inner and outer contours of the piston block are tightly fitted against the transparent test tube and the detection bottle respectively, and the light-guiding layer is disposed in the middle of the interior of the piston block, so that the light-guiding layer can guide the color of the clear water in the transparent test tube to a surface of the detection bottle. By the foregoing design, when the color of the solution in the detection bottle changes at the cloud point, test personnel or a visual detection device can determine that the cloud point of the silicone surfactant is reached based on the light-guiding layer and an obvious change in the color of the solution. Current water temperature can be directly monitored by using the thermometer in the detection transparent test tube. This design achieves high-precision, efficient, and simplified cloud point measurement of the silicone surfactant.

2. In the present application, the electric control push rod can drive the sewage discharge seat to move up, so that the butt pipe can slide in the through groove and enter the drainage groove. When the butt pipe enters the drainage groove and continues to move upward, the butt pipe can push open the water-isolating valve layer and enter the detection bottle, so that the detected solution in the detection bottle can enter the sewage discharge seat under the guiding of the butt pipe. Because an opening diameter of the water inlet pipe is designed to be larger than an opening diameter of the butt pipe, a water inlet speed is faster than a drainage speed. During drainage, test personnel inject clear water into the water inlet pipe to fill space between the interior of the detection bottle and the bottom of the piston block, thereby using the clear water to wash away the solution that is highly splashed during stirring. This design effectively prevents remaining of the silicone surfactant in the detection bottle from affecting subsequent detection. Sewage entering the sewage discharge seat passes through the sewage discharge hose and is discharged out of the sewage discharge port. The device can be quickly cleaned by the foregoing operations, which facilitates the cloud point detection of a silicone surfactant in the next batch, thereby improving detection efficiency of the device.

3. In the present application, the air inlet pipe and the air outlet pipe are respectively connected to an air delivery pump and an air extraction pump. During drainage of the device, high-pressure gas is injected into the detection bottle through the air inlet pipe by using the air delivery pump. Under high pressure of the high-pressure gas, the piston block can move in the detection bottle. After the piston block touches the water surface during movement, a water flow speed is accelerated, and the drainage speed of the device after cleaning of the detection bottle is accelerated, thereby further improving working efficiency of the device. The piston block can scrape off water adhered to the inner wall of the detection bottle during movement. This design can also effectively avoid remaining of the silicone surfactant in the device. In addition, the piston block moves downward, which can effectively avoid remaining of water at the bottom of the detection bottle, and can effectively avoid the problem that water cannot be completely discharged out of the detection bottle. After drainage, the gas can be extracted from the detection bottle through the air outlet pipe by using the air extraction pump. When the gas is extracted from the detection bottle, the piston block moves upward in the detection bottle to the original position due to decrease in air pressure. When moving to the original position, the piston block can clean the inner wall of the detection bottle again. By this design, the vertical position of the piston block can be adjusted flexibly. By adjusting the piston block to ensure that the volume of the detection bottle is matched with the volume of a to-be-detected solution, the test personnel can quickly judge whether a prepared volume of solution is correct after pouring the to-be-detected solution into the detection bottle, which can effectively reduce the detection error rate of the device.

### DESCRIPTION OF DRAWINGS

FIG. 1 is a schematic diagram of an integral stereochemical structure of a cloud point measuring apparatus for a silicone surfactant of the present application;

FIG. 2 is a schematic diagram of an internal structure of a sewage discharge assembly of a cloud point measuring apparatus for a silicone surfactant of the present application;

FIG. 3 is a schematic structural diagram of a heating and stirring assembly of a cloud point measuring apparatus for a silicone surfactant of the present application;

FIG. 4 is a schematic diagram of an internal structure of a detection assembly of a cloud point measuring apparatus for a silicone surfactant of the present application;

FIG. 5 is a schematic structural diagram of a piston block of a cloud point measuring apparatus for a silicone surfactant of the present application; and

FIG. 6 is a schematic diagram of an integral sectional structure of a cloud point measuring apparatus for a silicone surfactant of the present application.

In the figures, 1: sewage discharge assembly; 101: a fixed seat; 102: electric control push rod; 103: sewage discharge seat; 104: butt pipe; 105: sewage discharge hose; 106: sewage discharge port; 2: heating and stirring assembly; 201: butt base; 202: heating layer; 203: magnetic stirrer; 204: through groove; 3: detection assembly; 301: detection bottle; 302: air inlet pipe; 303: air outlet pipe; 304: drainage groove; 305: water-isolating valve layer; 306: water inlet pipe; 307: butt joint; 4: magnetic rotor; 5: first fixed plug; 6: transparent test tube; 7: second fixed plug; 8: thermometer; 9: piston block; and 10: light-guiding layer.

### DETAILED DESCRIPTION

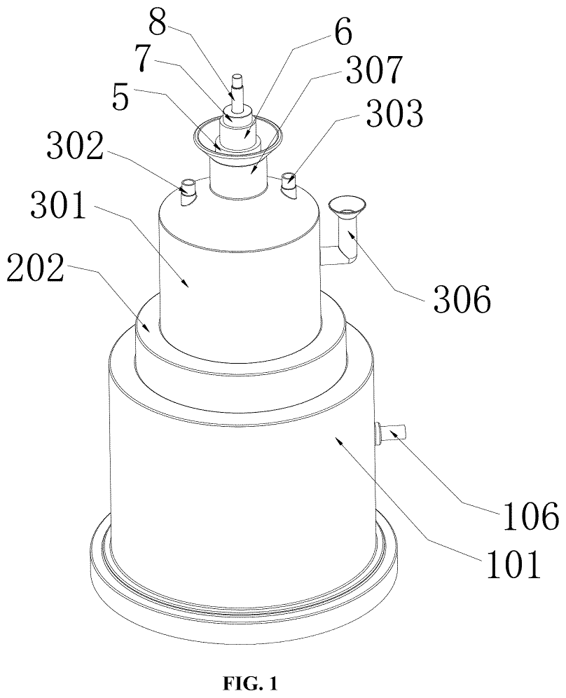

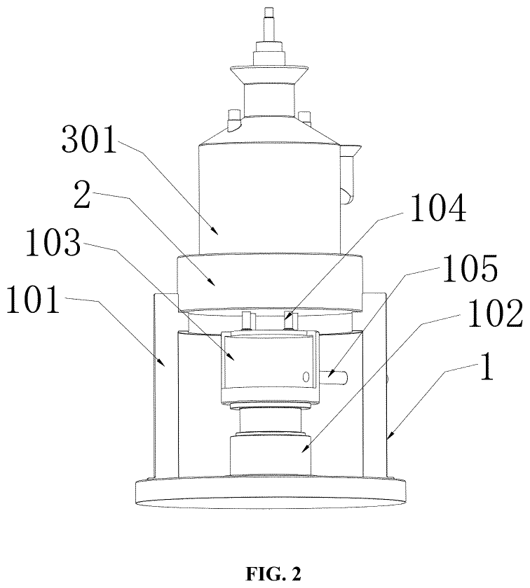

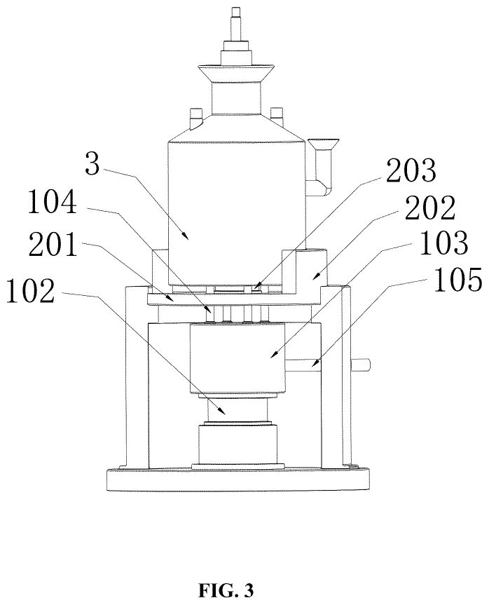

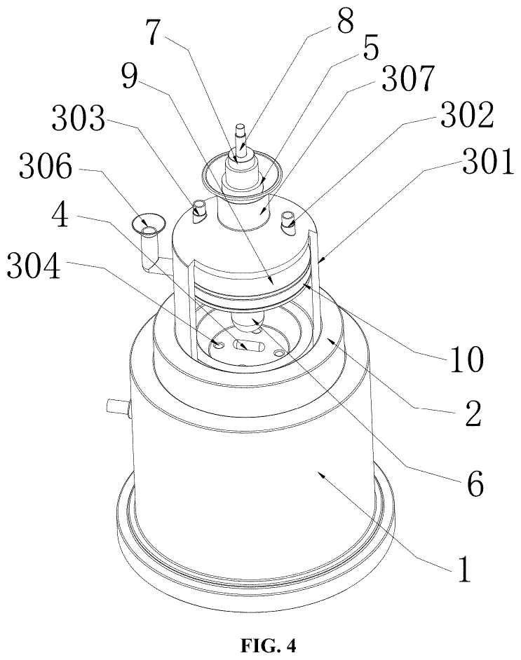

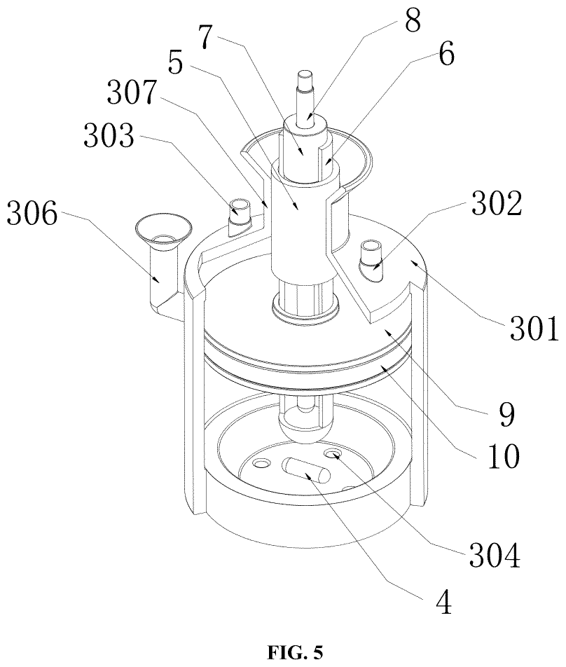

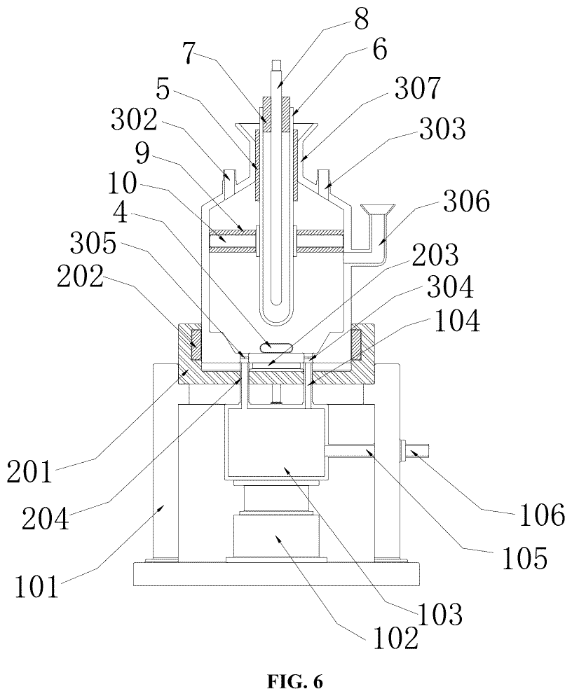

Refer to FIG. 1 to FIG. 6. The present application provides the following technical solution: a cloud point measuring apparatus for a silicone surfactant, which includes a sewage discharge assembly 1, a heating and stirring assembly 2, and a detection assembly 3. The heating and stirring assembly 2 is disposed outside the top of the sewage discharge assembly 1, and the detection assembly 3 is disposed outside the top of the heating and stirring assembly 2. The detection assembly 3 includes a detection bottle 301, an air inlet pipe 302, an air outlet pipe 303, a drainage groove 304, a water-isolating valve layer 305, a water inlet pipe 306, and a butt joint 307. The air inlet pipe 302 is connected to a left end of the top of the detection bottle 301, the air outlet pipe 303 is arranged at a right end of the top of the detection bottle 301, the drainage groove 304 is formed at the bottom of the detection bottle 301, the water-isolating valve layer 305 is disposed inside the drainage groove 304, the water inlet pipe 306 is connected to the exterior of the detection bottle 301, the butt joint 307 is arranged on the top of the detection bottle 301, and a magnetic rotor 4 is disposed at the inner bottom of the detection bottle 301.

Refer FIG. 1 to FIG. 6. The sewage discharge assembly 1 includes a fixed seat 101, an electric control push rod 102, a sewage discharge seat 103, a butt pipe 104, a sewage discharge hose 105, and a sewage discharge port 6. The electric control push rod 102 is arranged in the middle of the interior of the fixed seat 101, the sewage discharge seat 103 is arranged at an output end of the electric control push rod 102, the butt pipe 104 is connected to the exterior of the top of the sewage discharge seat 103, the sewage discharge hose 105 is connected to the exterior of the sewage discharge seat 103, the sewage discharge port 106 is arranged at the exterior of the fixed seat 101, the butt pipe 104 is communicated with the sewage discharge hose 105 through the sewage discharge seat 103, and the sewage discharge hose 105 is communicated with the sewage discharge port 106. The heating and stirring assembly 2 includes a butt base 201, a heating layer 202, a magnetic stirrer 203, and a through groove 204. The heating layer 202 is arranged inside the butt base 201, the magnetic stirrer 203 is arranged in the middle of the interior of the butt base 201, and the through groove 204 is formed inside the butt base 201. An outer contour of the detection bottle 301 is matched with an inner contour of the butt base 201, and a bottom surface of the detection bottle 301 is tightly fitted against a top surface of the magnetic stirrer 203. The magnetic stirrer 203 drives the magnetic rotor 4 to rotate, and the position and dimension of the through groove 204 are in one-to-one correspondence with the position and dimension of the butt pipe 104. The air inlet pipe 302, the air outlet pipe 303, and the water inlet pipe 306 are communicated with the interior of the detection bottle 301, and the detection bottle 301 and the butt joint 307 are integrated. A first fixed plug 5 is disposed inside the butt joint 7, a transparent test tube 6 is disposed inside the first fixed plug 5, a second fixed plug 7 is disposed on inner side of the top of the transparent test tube 6, a thermometer 8 is disposed inside the second fixed plug 7, a piston block 9 is arranged inside the detection bottle 301, and a light-guiding layer 10 is arranged in the middle of the interior of the piston block 9. The electric control push rod 102 drives the butt pipe 104 to move upward to push open the water-isolating valve layer 305 and pass through the drainage groove 304, and the butt pipe 104 is communicated with the interior of the detection bottle 301 after passing through the drainage groove 304. An outer contour of the piston block 9 is tightly fitted against an inner wall of the detection bottle 301, and an outer contour of the piston block 9 is tightly fitted against an outer wall of the transparent test tube 6.

A specific operation process is as follows: test personnel places the magnetic rotor 4 in the detection bottle 301 and allows the magnetic rotor 4 to reach the top of the detection bottle 301. Then, the test personnel engages the first fixed plug 5 with the butt joint 307, and inserts the transparent test tube 6 into the first fixed plug 5, so that the transparent test tube 6 can be fixed to the butt joint 307 through the first fixed plug 5. The test personnel adjusts a vertical position of the transparent test tube 6 in the detection bottle 301 to ensure that the transparent test tube 6 will be immersed in a to-be-detected solution. The detection bottle 301 is made from a transparent quartz material, so that the vertical position of the transparent test tube 6 in the detection bottle 301 can be directly adjusted. After adjusting the vertical position of the transparent test tube 6, the test personnel injects clear water into the transparent test tube 6, and places the thermometer 8 in the transparent test tube 6. The thermometer 8 is fixed to the transparent test tube 6 through the second fixed plug 7, which can ensure stable fixed connection between the thermometer 8 and the transparent test tube 6. After placing and fixing the thermometer 8, the test personnel places the detection bottle 301 on the top of the butt base 201, which allows an outer wall of the detection bottle 301 to touch the heating layer 202 and the bottom surface of the detection bottle 301 to touch the magnetic stirrer 203. After placing the detection bottle 301 on the top of the butt base 201, the test personnel mixes a to-be-detected silicone surfactant with deionized water in a ratio of 1:99, and injects the mixed solution into the detection bottle 301 through the water inlet pipe 306. The water-isolating valve layer 305 at the bottom of the detection bottle 301 can prevent the solution from leaking from the drainage groove 304. At this point, preparation work before detection is completed. During detection of the apparatus, the solution in the detection bottle 301 is heated by using the heating layer 202. The magnetic stirrer 203 drives the magnetic rotor 4 to rotate, and the magnetic rotor 4 can mix the solution during rotation to ensure that the silicone surfactant is uniformly mixed with the deionized water. When the temperature rises to a cloud point of the silicone surfactant, the solution becomes turbid and the color changes. Because the clear water in the transparent test tube 6 is not contact with the solution in the detection bottle 301, the clear water always remains clear. The inner and outer contours of the piston block 9 are tightly fitted against the transparent test tube 6 and the detection bottle 301 respectively, and the light-guiding layer 10 is disposed in the middle of the interior of the piston block 9, so that the light-guiding layer 10 can guide the color of the clear water in the transparent test tube 6 to a surface of the detection bottle 301. By the foregoing design, when the color of the solution in the detection bottle 301 changes at the cloud point, the test personnel or a visual detection device can determine that the cloud point of the silicone surfactant is reached based on the light-guiding layer 10 and an obvious change in the color of the solution. Current water temperature can be directly monitored by using the thermometer 8 in the transparent test tube 6. This design can achieve high-precision, efficient, and simplified turbidity potion measurement of the silicone surfactant. After the cloud point of the silicone surfactant is detected, the electric control push rod 102 can drive the sewage discharge seat 103 to move upward, so that the butt pipe 104 can slide in the through groove 204 and enter the drainage groove 304. When the butt pipe 104 enters the drainage groove 304 and continues to move upward, the butt pipe 104 can push open the water-isolating valve layer 305 and enter the detection bottle 301, so that the detected solution in the detection bottle 301 can enter the sewage discharge seat 103 under the guiding of the butt pipe 104. Because an opening diameter of the water inlet pipe 306 is designed to be larger than an opening diameter of the butt pipe 104, a water inlet speed is higher than a drainage speed. During drainage, the test personnel injects clear water through the water inlet pipe 306 to fill space between the interior of the detection bottle 301 and the bottom of the piston block 9, thereby using the clear water to wash away the solution that is highly splashed during stirring. This design can effectively prevent remaining of the silicone surfactant in the detection bottle 301 from affecting subsequent detection. Sewage entering the sewage discharge seat 103 passes through the sewage discharge hose 105 and is discharged out of the sewage discharge port 106. The device can be quickly cleaned through the foregoing operations, which facilitates the detection of a silicone surfactant in the next batch, thereby improving detection efficiency of the device. The air inlet pipe 302 and the air outlet pipe 303 are respectively connected to an air delivery pump and an air extraction pump. During drainage of the device, high-pressure gas is injected into the detection bottle 301 through the air inlet pipe 302 by using the air delivery pump. Under high pressure of the high-pressure gas, the piston block 9 can move in the detection bottle 301. After the piston block 9 touches the water surface during movement, a water flow speed is accelerated, and the drainage speed of the device after cleaning of the detection bottle 301 is accelerated, thereby further improving working efficiency of the device. The piston block 9 can scrape off water adhered to the inner wall of the detection bottle 301 during movement. This design can also effectively avoid remaining of the silicone surfactant in the device. In addition, the piston block 9 moves downward, which can effectively avoid remaining of water at the bottom of the detection bottle 301, and can effectively avoid the problem that water cannot be completely discharged out of the detection bottle 301. After drainage, the gas can be extracted from the detection bottle 301 through the air outlet pipe 303 by using the air extraction pump. When the gas is extracted from the detection bottle 301, the piston block 9 moves upward in the detection bottle 301 to the original position due to decrease in air pressure. When moving to the original position, the piston block 9 can clean the inner wall of the detection bottle 301 again. By this design, the vertical position of the piston block 9 can be adjusted flexibly. By adjusting the piston block 9 to ensure that the volume of the detection bottle 301 is matched with the volume of a to-be-detected solution, the test personnel can quickly judge whether a prepared volume of solution is correct after pouring the to-be-detected solution into the detection bottle, which can effectively reduce the detection error rate of the device.

In conclusion, during use of the cloud point measuring apparatus for a silicone surfactant, firstly, the test personnel places the magnetic rotor 4 in the detection bottle 301 to allow the magnetic rotor 4 to reach the top of the detection bottle 301. Then, the test personnel engages the first fixed plug 5 with the butt joint 307, and inserts the transparent test tube 6 into the first fixed plug 5, so that the transparent test tube 6 can be fixed to the butt joint 307 through the first fixed plug 5. The test personnel adjusts the vertical position of the transparent test tube 6 in the detection bottle 301 to ensure that the transparent test tube 6 will be immersed in the to-be-detected solution. The detection bottle 301 is made from the transparent quartz material, so that the vertical position of the transparent test tube 6 in the detection bottle 301 can be directly adjusted.

After the vertical position of the transparent test tube 6 is adjusted, the test personnel injects clear water into the transparent test tube 6, and places the thermometer 8 into the transparent test tube 6. The thermometer 8 is fixed to the transparent test tube 6 through the second fixed plug 7, which can ensure stable fixed connection between the thermometer 8 and the transparent test tube 6. After placing and fixing the thermometer 8, the test personnel places the detection bottle 301 on the top of the butt base 201, which allows the outer wall of the detection bottle 301 to touch the heating layer 202 and the bottom surface of the detection bottle 301 to touch the magnetic stirrer 203. After placing the detection bottle 301 on the top of the butt base 201, the test personnel mixes the to-be-detected silicone surfactant with deionized water in the ratio of 1:99, and injects the mixed solution into the detection bottle 301 through the water inlet pipe 306. The water-isolating valve layer 305 at the bottom of the detection bottle 301 can prevent the solution from leaking from the drainage groove 304. At this point, preparation work before detection is completed.

The solution in the detection bottle 301 is heated by using the heating layer 202. The magnetic stirrer 203 drives the magnetic rotor 4 to rotate, and the magnetic rotor 4 can mix the solution during rotation to ensure that the silicone surfactant is uniformly mixed with the deionized water. When the temperature rises to the cloud point of the silicone surfactant, the solution becomes turbid and the color changes. Because the clear water in the transparent test tube 6 is not in contact with the solution in the detection bottle 301, the clear water can always remain clear. The inner and outer contours of the piston block 9 are tightly fitted against the transparent test tube 6 and the detection bottle 301 respectively, and the light-guiding layer 10 is disposed in the middle of the interior of the piston block 9, so that the light-guiding layer 10 can guide the color of the clear water in the transparent test tube 6 to the surface of the detection bottle 301. By the foregoing design, when the color of the solution in the detection bottle 301 changes at the cloud point, the test personnel and the visual detection device can determine that the cloud point of the silicone surfactant is reached based on the light-guiding layer 10 and the obvious change in the color of the solution. Current water temperature can be directly monitored by using the thermometer 8 in the transparent test tube 6. This design can achieve high-precision, efficient, and simplified cloud point measurement of the silicone surfactant.

After the cloud point of the silicone surfactant is detected, the electric control push rod 102 drives the sewage discharge seat 103 to move upward, so that the butt pipe 104 can slide in the through groove 204 and enter the drainage groove 304. When the butt pipe 104 enters the drainage groove 304 and continues to move upward, the butt pipe 104 can push open the water-isolating valve layer 305 and enter the detection bottle 301, so that the detected solution in the detection bottle 301 can enter the sewage discharge seat 103 under the guiding of the butt pipe 104. Because the opening diameter of the water inlet pipe 306 is designed to be larger than the opening diameter of the butt pipe 104, the water inlet speed is higher than the drainage speed. During drainage, the test personnel injects clear water into the water inlet pipe 306 to fill the space between the interior of the detection bottle 301 and the bottom of the piston block 9, thereby using the clear water to wash away the solution that is highly splashed during stirring. This design can effectively prevent remaining of the silicone surfactant in the detection bottle 301 from affecting subsequent detection. The sewage entering the sewage discharge seat 103 passes through the sewage discharge hose 105 and is discharged out of the sewage discharge port 106. The device can be quickly cleaned by the foregoing operations, which facilitates the detection of a silicone surfactant in the next batch, thereby improving detection efficiency of the device.

Finally, during drainage of the device, high-pressure gas is injected into the detection bottle 301 through the air inlet pipe 302 by using the air delivery pump. Under high pressure of the high-pressure gas, the piston block 9 can move in the detection bottle 301. When the piston block 9 touches the water surface during movement, the water flow speed is accelerated, and the drainage speed of the device after cleaning of the detection bottle 301 is accelerated, thereby further improving working efficiency of the device. The piston block 9 can scrape off water adhered to the inner wall of the detection bottle 301 during movement. This design can also effectively avoid remaining of the silicone surfactant in the device. In addition, the piston block 9 moves downward, which can effectively avoid remaining of water at the bottom of the detection bottle 301, and can effectively avoid the problem that water cannot be completely discharged out of the detection bottle 301. After drainage, the gas can be extracted from the detection bottle 301 through the air outlet pipe 303 by using the air extraction pump. When the gas is extracted from the detection bottle 301, the piston block 9 moves upward in the detection bottle 301 to the original position due to decrease in air pressure. When moving to the original position, the piston block 9 can clean the inner wall of the detection bottle 301 again. By this design, the vertical position of the piston block 9 can be adjusted flexibly. By adjusting the piston block 9 to ensure that the volume of the detection bottle 301 is matched with the volume of a to-be-detected solution, the test personnel can quickly judge whether a prepared volume of solution is correct after pouring the to-be-detected solution into the detection bottle, which can effectively reduce the detection error rate of the device.

The embodiments of the present application are provided for the purpose of illustration and description, and are not intended to be exhaustive or limit the present application in the form disclosed. Many modifications and changes will be apparent to those of ordinary skill in the art. The embodiments are selected and described for the purpose of better explaining the principles and practical application of the present application, to enable those skilled in the art to understand the present application and design various embodiments with various modifications that are suited to the particular use contemplated.

What is claimed is:

1. A cloud point measuring apparatus for a silicone surfactant, comprising a sewage discharge assembly, a heating and stirring assembly, and a detection assembly, wherein the heating and stirring assembly is disposed outside the top of the sewage discharge assembly, the detection assembly is disposed outside the top of the heating and stirring assembly, the detection assembly comprises a detection bottle, an air inlet pipe, an air outlet pipe, a drainage groove, a water-isolating valve layer, a water inlet pipe, and a butt joint, the air inlet pipe is connected to a left end of the top of the detection bottle, the air outlet pipe is arranged at a right end of the top of the detection bottle, the drainage groove is formed at the bottom of the detection bottle, the water-isolating valve layer is disposed inside the drainage groove, the water inlet pipe is connected to the exterior of the detection bottle, the butt joint is arranged on the top of the detection bottle, and a magnetic rotor is disposed at the inner bottom of the detection bottle.

2. The cloud point measuring apparatus for a silicone surfactant according to claim 1, wherein the sewage discharge assembly comprises a fixed seat, an electric control push rod, a sewage discharge seat, a butt pipe, a sewage discharge hose, and a sewage discharge port, wherein the electric control push rod is arranged in the middle of the interior of the fixed seat, the sewage discharge seat is arranged at an output end of the electric control push rod, the butt pipe is connected to the exterior of the top of the sewage discharge seat, the sewage discharge hose is connected to the exterior of the sewage discharge seat, and the sewage discharge port is arranged at the exterior of the fixed seat.

3. The cloud point measuring apparatus for a silicone surfactant according to claim 2, wherein the butt pipe is communicated with the sewage discharge hose through the sewage discharge seat, and the sewage discharge hose is communicated with the sewage discharge port.

4. The cloud point measuring apparatus for a silicone surfactant according to claim 2, wherein the heating and stirring assembly comprises a butt base, a heating layer, a magnetic stirrer, and a through groove, wherein the heating layer is arranged inside the butt base, the magnetic stirrer is arranged in the middle of the interior of the butt base, and the through groove is formed inside the butt base.

5. The cloud point measuring apparatus for a silicone surfactant according to claim 4, wherein an outer contour of the detection bottle is matched with an inner contour of the butt base, and a bottom surface of the detection bottle is tightly fitted against a top surface of the magnetic stirrer.

6. The cloud point measuring apparatus for a silicone surfactant according to claim 4, wherein the magnetic stirrer drives the magnetic rotor to rotate, and the position and dimension of the through groove are in one-to-one correspondence with the position and dimension of the butt pipe.

7. The cloud point measuring apparatus for a silicone surfactant according to claim 1, wherein the air inlet pipe, the air outlet pipe, and the water inlet pipe are communicated with the interior of the detection bottle, and the detection bottle and the butt joint are integrated.

8. The cloud point measuring apparatus for a silicone surfactant according to claim 2, wherein a first fixed plug is disposed inside the butt joint, a transparent test tube is disposed inside the first fixed plug, a second fixed plug is disposed on an inner side of the top of the transparent test tube, a thermometer is disposed inside the second fixed plug, a piston block is arranged inside the detection bottle, and a light-guiding layer is arranged in the middle of the interior of the piston block.

9. The cloud point measuring apparatus for a silicone surfactant according to claim 8, wherein the electric control push rod drives the butt pipe to move upward to push open the water-isolating valve layer and pass through the drainage groove, and the butt pipe is communicated with the interior of the detection bottle after passing through the drainage groove.

10. The cloud point measuring apparatus for a silicone surfactant according to claim 8, wherein an outer contour of the piston block is tightly fitted against an inner wall of the detection bottle, and an inner contour of the piston block is tightly fitted against an outer wall of the transparent test tube.
